(19) United States
(12) Patent Application Publication
(10) Pub. No.: US 2009/0263290 A1
(43) Pub. Date: Oct. 22, 2009

(54) CAPILLARY STORAGE AND DISPENSING CONTAINER

(76) Inventors: Tom Weisan Yang, Cupertino, CA (US); David J. Roach, Los Gatos, CA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/426,166

(22) Filed: Apr. 17, 2009

Related U.S. Application Data
(63) Continuation-in-part of application No. 11/893,733, filed on Aug. 17, 2007.
Application No. 11/893,733 is a continuation-in-part of application No. 11/401,699, filed on Apr. 10, 2006.
(60) Provisional application No. 60/669,694, filed on Apr. 9, 2005.

(51) Int. Cl. B01L 9/06

(52) U.S. Cl. 422/104

(57) ABSTRACT

A polymeric injection-molded container is described which holds capillaries for a biological material assay system in a vertical position. The container includes a two-piece base which is press-fit together. Ninety-six funnel-shaped holes in the top of the base receive the capillaries and support them circumferentially. Ninety-six apertures in the bottom of the base are tapered to guide the bottom ends of the capillaries to positions aligned with the holes in the top of the base. The inserted capillaries extend above the top surface of the base and are covered by a removable cover. The capillaries can be processed and placed in the container by the capillary manufacturer, shipped to a user in the container, and the container can be placed on the capillary holder station of an automated assay system and used by the automated system directly from the container.

### CROSS REFERENCE TO RELATED APPLICATIONS

This application is a continuation-in-part of U.S. patent application Ser. No. 11/893,733 filed Aug. 17, 2007, which is continuation-in-part of U.S. patent application Ser. No. 11/401,699 filed Apr. 10, 2006, which claims the benefit of U.S. provisional application No. 60/669,694, filed on Apr. 9, 2005, all of which are incorporated by reference herein in their entirety.

### FIELD OF THE INVENTION

Embodiments of the present invention relate generally to assay systems for assaying volumes of biological substances in capillaries and, in particular, to a container for transporting and storing the capillaries and dispensing them during use of the assay system.

### BACKGROUND OF THE INVENTION

A number of methods and systems have been developed for conducting various processing and/or analyses of biological substances, such as those described in U.S. Pat. No. 6,423,536 for temperature cycling processes, U.S. Pat. Nos. 5,843,680, 5,784,154, 5,395,502, and 5,137,609 for separation assay methods, U.S. Pat. No. 5,785,926 for a capillary transport system, international publication WO94/13829 for an isoelectric focusing separation assay system, and U.S. Pat. No. 6,430,512 for a chromatographic fluorescence separation and display system.

U.S. Pat. App. Pub. Nos.: 20060029978 and 20030032035, the disclosures of all of which are incorporated herein by reference, describe apparatus and methods for assaying microliter volumes of cellular material by separating constituent substances of the material in a fluid chamber such as a capillary, binding the separated substances in place, then eliciting an optical response from the bound substances such as fluorescence or chemiluminescence. The resulting information has content similar to that of a Western gel blot but without the complex, extensive and time-consuming handling and processing steps that adversely affect reproducibility and make automation difficult. This technique also has advantages such as the ability to assay very small volumes of materials such as those on the cellular level, and good sensitivity due to the ability to receive optical data from chemiluminescence for as long as necessary to obtain a desirable output signal level. However, it would be desirable to automate this technique so that multiple samples may be analyzed simultaneously or in rapid succession with ease and robustness while only consuming minimal volumes of precious reagents and expensive disposables. It is also desirable to develop a container for transporting and storing the capillaries and dispensing them during use of the assay system.

### SUMMARY OF THE INVENTION

In accordance with the principles of the present invention, in some embodiments, a capillary container is provided in which the capillaries can be shipped from the manufacturer and stored by the user prior to use in an automated micro-volume assay system. The container includes a cover which protects coated capillaries from environmental hazards prior to use. The container holds the capillaries in a vertical position so that the base of the container can be used as a capillary rack in the automated assay system. To enable the container and capillaries to be used in an automated assay system without machine vision, the capillaries are positioned on pre-determined center-to-center spacings which can be programmed into the control computer of the assay system.

In various embodiments, the capillary container holds a plurality of capillaries in a vertical position which is suitable for use in an automated assay system and the container comprises: a removable cover which can be secured on top of the container, the cover providing clearance for the upper portions of a plurality of capillaries which are loaded into the container; and a base having a plurality of holes arranged in a grid-like pattern which hold capillaries in an upright vertical position, the holes holding the capillaries in a vertical orientation by circumferentially surrounding the capillaries, the base having a lower portion with positions aligned vertically with the tops of the holes which support the capillaries at the bottom ends of the capillaries.

In some embodiments, the holes are funnel-shaped at the top to provide for ease in insertion of the capillaries into the holes. In some embodiments, the holes are arranged in a grid-like pattern of ninety-six holes of eight rows of twelve holes, whereby a fully loaded container contains ninety-six capillaries. In some embodiments, the holes are arranged in a grid-like pattern of 384 holes of sixteen rows of twenty-four holes, whereby a fully loaded container contains 384 capillaries. In some embodiments, the positions supporting the capillaries at the bottom ends comprise tapered apertures each of which guides an inserted capillary to a position vertically aligned with the top a hole which is slightly larger than the diameter of a capillary. In some embodiments, the base measures approximately 1.6 inches by 2.5 inches. In some embodiments, the grid-like pattern of holes further comprises a plurality of holes with a 0.18 inch center-to-center spacing. In some embodiments, the base exhibits a space between the part of the holes which circumferentially surround the capillaries at the top of the hole and the lower portion which supports the capillaries at the bottom ends of the capillaries.

In various embodiments, the base further comprises: a top surface having a plurality of funnel-shaped holes formed therein, and a support structure, located beneath the top surface, which provides rigidity to the top surface.

In various embodiments, the base further comprises: an upper portion including a top surface having the plurality of funnel-shaped holes arranged in the grid-like pattern which support vertically oriented capillaries by providing circumferential support to the capillaries; and a lower portion providing the inside bottom of the container and providing the positions vertically aligned with the tops of the holes of the top surface, the lower portion supporting the capillaries at the bottom ends of the capillaries.

In another aspect, the present invention provides an injection molded polymeric capillary container which holds ninety-six capillaries in a vertical position. The container comprises: a polymeric base which holds the capillaries in a vertical position by a top surface with ninety-six holes which circumferentially surround the- capillaries, with the capillaries extending over one-half inch above the top surface, and a bottom which supports the bottom ends of the capillaries in ninety-six predetermined positions which are vertically aligned with the holes of the top surface; and a polymeric cover which removably fits over the top of the base and covers the capillaries that are located in the base.

In various embodiments, the polymer is electrically conductive to retard static buildup. In some embodiments, the polymeric base comprises two portions: an upper portion having a structurally reinforced top surface containing ninety-six funnel shaped holes for receiving capillaries; and a lower portion which press-fits together with the upper portion, the lower portion having ninety-six centering supports which support the ends of capillaries in vertical alignment with the funnel shaped holes and are tapered to locate the ends of the capillaries at the ninety-six positions.

In various embodiments, the polymeric base further includes a shoulder which defines the position of the cover when the cover is fit over the top of the base, the defined position providing a space between the cover and the base into which capillaries loaded into the container can extend, the capillaries extending over half of the distance between the top of the base and the cover.

In various embodiments, the present invention provides a capillary container comprising: a removable cover which can be secured on top of the container, the cover providing clearance for the upper portions of a plurality of capillaries which are loaded into the container; and a base having a plurality of holes arranged in a grid-like pattern which hold capillaries in an upright vertical position, the holes holding the capillaries in a vertical orientation by circumferentially surrounding the capillaries, the base having a lower portion with positions aligned vertically with the tops of the holes which support the capillaries at the bottom ends of the capillaries, wherein said container holds 96 capillaries with about 4.5 mm center-to-center spacing.

In various embodiments, the present invention provides an injection molded polymeric capillary container which holds ninety-six capillaries in a vertical position. The container comprises: a polymeric base which holds the capillaries in a vertical position by a top surface with ninety-six holes which circumferentially surround the- capillaries, with the capillaries extending over one-half inch above the top surface, and a bottom which supports the bottom ends of the capillaries in ninety-six predetermined positions which are vertically aligned with the holes of the top surface; and a polymeric cover which removably fits over the top of the base and covers the capillaries that are located in the base, wherein said container holds capillaries with about 4.5 mm center-to-center spacing.

### BRIEF DESCRIPTION OF THE DRAWINGS

FIG. 1 is a perspective assembly drawing of the cover and upper and lower sections of the base of a capillary storage and dispensing container constructed in accordance with the principles of the present invention.

FIGS. 2a-2d are plan and cross-sectional views of the cover of a capillary storage and dispensing container of the present invention.

FIG. 3 is a perspective view of the base of a capillary storage and dispensing container of the present invention.

FIGS. 4a-4g are plan and cross-sectional views of the upper section of the base of a capillary storage and dispensing container of the present invention.

FIGS. 5a-5e are plan and cross-sectional views of the lower section of a base of a capillary storage and dispensing container of the present invention which fits together with the upper section of FIGS. 4a-4g.

FIG. 6 is a perspective view, looking upward at the underside of the base of FIG. 3.

FIG. 7 is a cutaway perspective view of a capillary storage and dispensing container of the present invention which is loaded with capillaries.

FIG. 8 illustrates a metallic capillary container in which the capillaries are supported in a vertical orientation by an intermediate support plate.

FIG. 9 is a perspective assembly drawing of the cover and upper and lower sections of the base of a capillary storage and dispensing container constructed in accordance with the principles of some embodiments of the present invention.

FIGS. 10a-10d are plan and cross-sectional views of the cover of a capillary storage and dispensing container according to some embodiments of the present invention.

FIG. 11 is a perspective view of the base of a capillary storage and dispensing container according to some embodiments of the present invention.

FIG. 12 is a perspective view, looking upward at the underside of the base of FIG. 11.

FIGS. 13a-13g are plan and cross-sectional views of the upper section of the base of a capillary storage and dispensing container according to some embodiments of the present invention.

FIGS. 14a-14e are plan and cross-sectional views of the lower section of a base of a capillary storage and dispensing container according to some embodiments of the present invention which fits together with the upper section of FIGS. 13a-13g.

FIG. 15 is a cutaway perspective view of a capillary storage and dispensing container of the present invention loaded with capillaries according to some embodiments of the present invention.

### DETAILED DESCRIPTION OF THE INVENTION

Embodiments of the present invention provide a container for transporting and storing the capillaries and dispensing them during use of an assay system.

U.S. Patent Application Publication No.: 2006/0249558 (Roach et al.), incorporated herein by reference, describes an automated micro-volume assay system in which a biological sample is introduced into a very small volume capillary. The constituent substances of the sample are separated electrophoretically, then bound in place to a coating which lines the capillary. An antibody to the proteins of interest is flowed through and binds to those proteins. A chemiluminescent reagent is flowed through the capillary which interacts with an enzyme attached to the antibody to elicit an optical response from the bound substances. The optical response is detected through the wall of the capillary by an optical detector, with the location of the optical emission providing an indication of a characteristic of the biological sample. Such an assay system provides information similar to that of a Western gel blot, but without the time-consuming handling and processing and ambiguities of the Western blot technique.

The assay system described in this patent application publication has a base on which reagents, biological samples, capillaries, and capillary holders are initially located in pre-determined positions. When operation of the system begins with the operative materials and components located in pre-assigned positions, the positions of the materials and components can be programmed into a computer that controls the system. The computer can then control the operation of various manipulators, stepper motors, and vacuum devices that automatically access the materials and components at their known positions on the base and carry out the processing of the assay system fully automatically. A key to making this automation effective without the complexity of machine vision is to know in advance the locations and positions of all of the materials and elements needed to conduct the process, and to program the system computer accordingly to automatically access them.

In the case of the capillaries, a pair of bulk capillary racks are located at specific capillary rack stations on the base of the assay system. The capillaries to be used in the process are initially located in these racks, then moved to a staging rack from which capillaries are selected for use in biological sample processing. The capillary racks hold capillaries upright in rows with a pre-defined center-to-center spacing. The pre-defined spacing permits the capillaries to be removed from the rack by a robotic computer-controlled capillary manipulator which is programmed and controlled to access the capillaries at their known locations.

However, initially loading the capillaries into the racks by hand can be challenging. The capillaries are very small with diameters on the order of 100 μm to 2 mm and lengths ranging from 30 to 100 mm. Handling the capillaries can contaminate them with body oils which can interfere with the optical properties necessary to detect the luminescence emitted from inside the capillaries. The buildup of electrostatic energy can cause both handling problems and attraction of particles which disrupt the use and function of the capillaries. Moreover, in the assay system described in this patent publication the capillaries are very closely spaced, with center-to-center spacings ranging from 4.5 mm to 9 mm. The density of capillaries in the capillary racks is also substantial, with a full rack holding 96 to 384 capillaries. The efficiency gained by fully automating the assay processing can be lost to the time required to insert the capillaries into the racks in preparation for system for operation.

Accordingly, it would be desirable for a system user to be able to buy the capillaries from the manufacturer pre-loaded in capillary racks which can be directly used in the capillary rack stations of the assay system, obviating the need to manually handle the capillaries prior to use.

Moreover, it would further be desirable to buy the capillaries pre-coated with the immobilizing coating so that the user does not have to spend time coating the capillaries and enduring the inefficiencies and vagaries associated therewith.

It is further desirable to protect the coated capillaries in containers which keep the capillaries secure from environmental hazards and physical damage prior to use.

It is also desirable to be able to ship and store the capillaries in the same containers, obviating the need to transfer them.

Reference will now be made in detail to various embodiments of the present invention(s), examples of which are illustrated in the accompanying drawings and described below. While the invention(s) are described in conjunction with exemplary embodiments, it will be understood that the present description is not intended to limit the invention(s) to those exemplary embodiments. On the contrary, the invention(s) is/are encompass not only the exemplary embodiments, but also various alternatives, modifications, equivalents and other embodiments, which are included within the spirit and scope of the invention as defined by the appended claims.

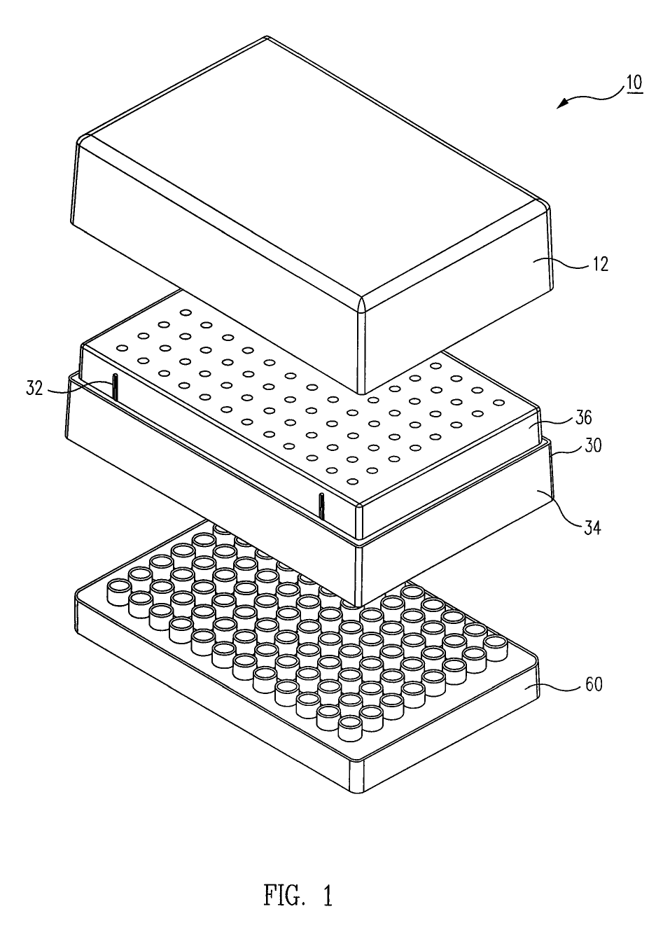

One exemplary embodiment of the invention is shown in FIGS. 1-8.

Referring first to FIG. 1, the parts of a capillary storage and dispensing container 10 constructed in accordance with the principles of the present invention are shown in a perspective assembly view. The container can be made of a variety of materials such as metal or plastic. A preferred material is acrylonitrile butadiene styrene (ABS), a thermoplastic copolymer which can advantageously be injection-molded to form the parts of the box. An advantage of ABS is that it combines the strength and rigidity of the acrylonitrile and styrene polymers with the toughness of the polybutadiene rubber. ABS can also be formulated to resist static buildup, which could cause handling or optical problems in the automated assay system. A suitable material is Cycolac® ABS plastic, which is available from GE Plastics of Pittsfield, Mass. ABS can also be formulated with additives to be electrically conductive and thereby reduce static buildup. Suitable ABS polymers with these electrical properties are LNP*Stat-kon* or LNP*Stat-loy*, both available from GE Plastics. Alternatively, the polymeric container can be coated with an anti-static coating.

The container 10 has a cover 12 which fits over a base that holds a plurality of capillaries in a vertical, upright position. The base is formed of two sections which press-fit together, an upper section 30 and a lower section 60. The bottom portion 34 of the upper section 30 is wider than the top portion 36 so that the cover 12 will fit over the top portion and cover the capillaries, while the bottom portion fits snugly over and around the lower section 60 of the base in a secure press-fit. When the top and bottom sections 30, 60 are mated together, the capillary holes in the top of the upper section 30 are in alignment with the capillary receivers of the lower section 60, which cooperate to hold the capillaries upright with the circumferential holes in the top and the funneled receivers in the bottom. The removable cover 12 is retained over the top portion 36 of the base by engagement with four ribs 32, two of which are molded on either side of the top portion 36 of the base.

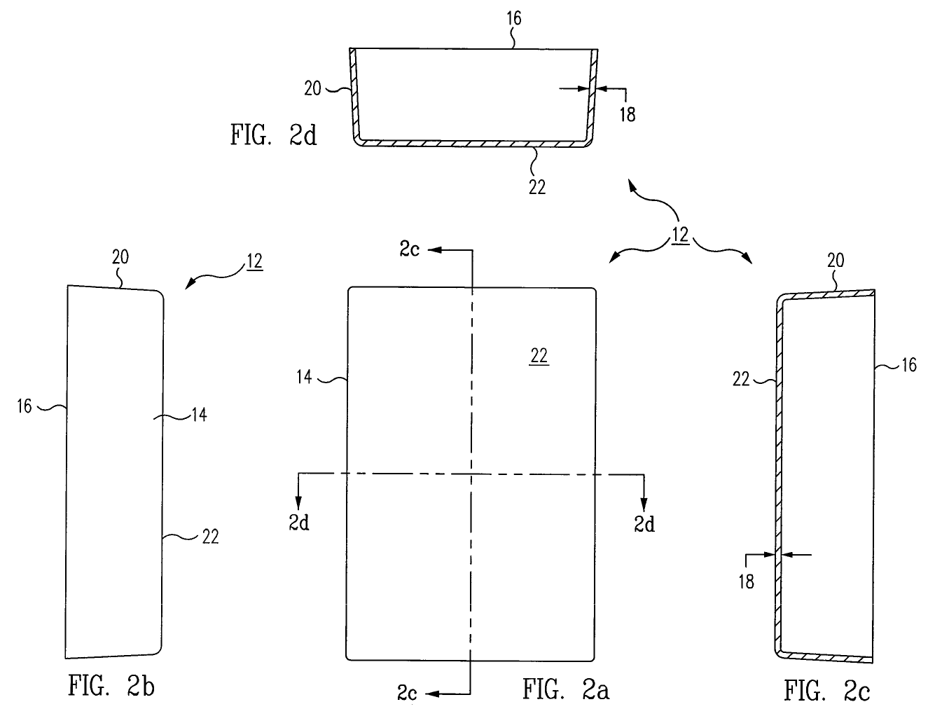

FIGS. 2a-2d show various views of the cover 12. FIG. 2a is a top plan view of the cover 12, which is about 3.3 inches wide, 5.0 inches long, and 1.4 inches high. FIG. 2b is a side plan view of the cover, FIG. 2c is a cross-sectional view taken along cut line 2c of FIG. 2a, and FIG. 2d is a cross-sectional view taken along cut line 2d of FIG. 2a. The cover has a nominal wall thickness 18 of about 0.08 inches. The sides 14, 20 of the cover are slightly inclined outward from the top 22 to the opening 16 so that the cover will easily engage the top portion 36 of the base.

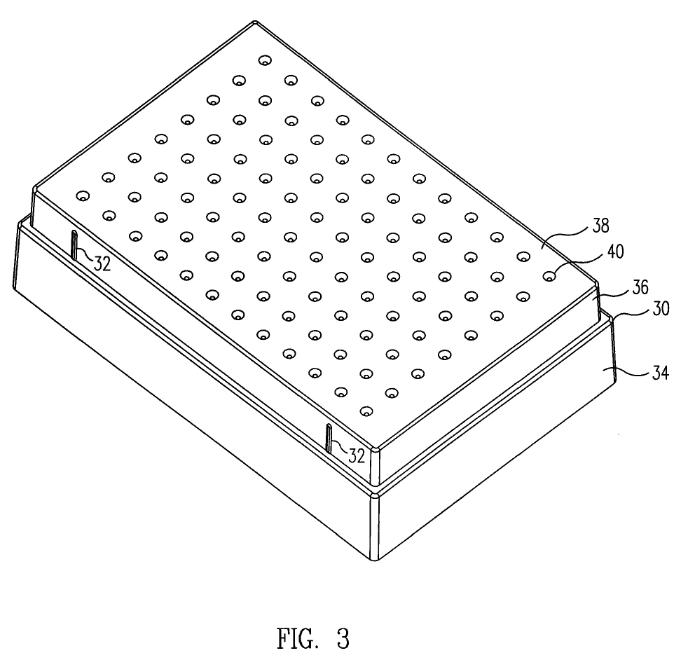

FIG. 3 is a perspective view looking at the top of the assembled base of the container 10. In this view only the upper section 30 of the base is visible because in the assembled base the lower section 60 of the base is fully inside the upper section with the bottom edges of both sections flush with each other and forming the bottom of the base. Holes 40 which hold the capillaries are formed through the top 38 of the upper section 30. Preferably the holes 40 are in a grid pattern which is familiar to and in common use in the biological assay field so that the container will hold a number of capillaries which is compatible with other assay equipment and devices. In the container shown in the drawings the grid of holes is eight holes wide by twelve holes long and the container will hold ninety-six capillaries when full. This is the same grid pattern as that of the familiar microwell plates used in biological assaying, as per ANSI standards ANSI/SBS 1-2004 and ANSI/SBS 4-2004. Thus, a container of ninety-six capillaries will exactly match the ninety-six well capacity of one of the standard microwell plates, and a container full of capillaries will be exactly what is needed to assay the samples in the ninety-six wells of the plate. Other convenient capillary capacities such as 384 capillaries may also be employed if desired.

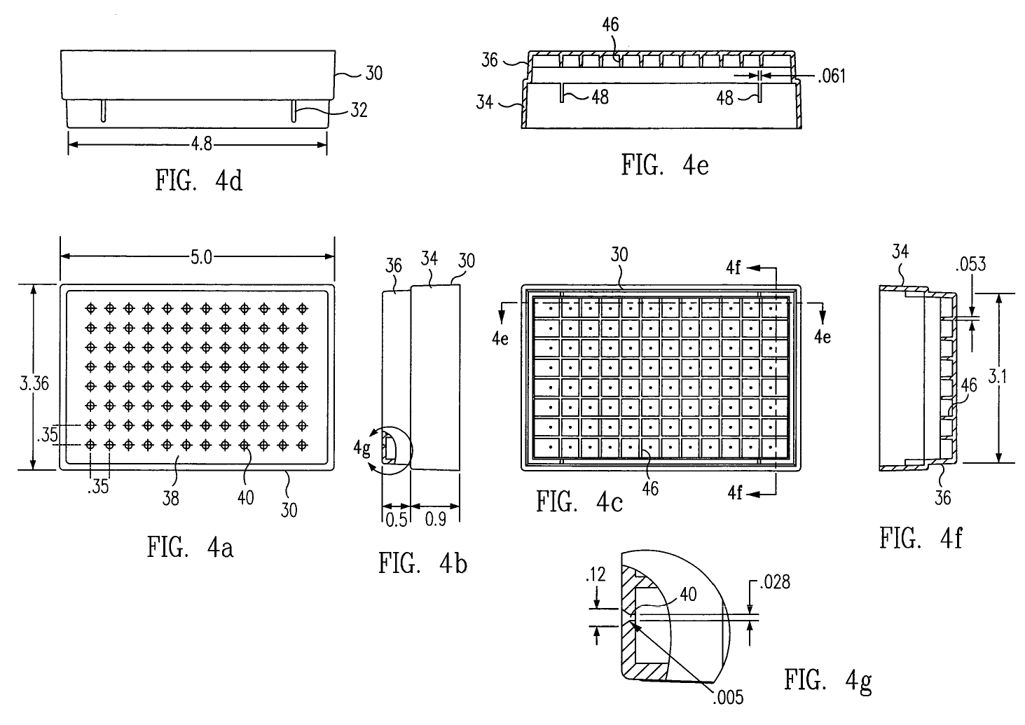

Details of the upper section 30 are shown in FIGS. 4a-4g. FIG. 4a is a top plan view of the upper section 30. The section 30 has a narrower upper portion 36 which is about one-half inch high, as shown in FIG. 4b. The cover 12 fits over this upper portion 36 and is retained in place by the four outer ribs 32. The wider lower portion 34 is about 0.9 inches high and forms the base of the container. The lower section 60 of the container fits inside this lower portion 34 and is retained in contact with ribs 48. Both portions are slightly tapered on the sides, with the base of the lower portion 34 measuring about 3.36 by 5.0 inches, which is sized to fit in the profile for a capillary rack on the base of the assay system with which it is to operate. If the footprint of the container is smaller than the size of the capillary rack station of the assay system, an adapter can be provided which fits the system footprint and accommodates the smaller container, in which case the container for the system operably includes the adapter. The top 38 measures about 3.1 by 4.8 inches as seen in FIGS. 4d and 4f. The ninety-six holes for the capillaries are located in the top surface as shown in FIG. 4a and the holes are evenly spaced on 0.35 inch (9 mm) centers in eight rows of twelve holes each as shown in this drawing. At the top the holes are funnel-shaped as best seen in the enlarged cutaway view of FIG. 4g. At the surface of the top 38 the capillary holes 40 have a diameter of 0.12 inches which tapers down to a diameter of 0.028 inches in the thickness of the top 38. The transition from the funnel shape to the constant diameter of the capillary hole 40 has about a 0.005 inch radius. The nominal diameter of 0.028 inches for the capillary holes is about twice the nominal diameter of a capillary.

To provide rigidity for the top surface 38 and prevent warping and bending, an egg-crate ribbing 46 is formed inside the upper portion 36. The sections of the ribs inside of the periphery are on the same 0.35 inch spacing as the capillary holes 40. The thickness of the ribbing 46 is about 0.053 inches as indicated in FIG. 4f. The ribbing 46 in FIGS. 4e and 4f is about 0.25 inches high in a constructed embodiment, occupying approximately the upper half of the inside of the upper portion 36.

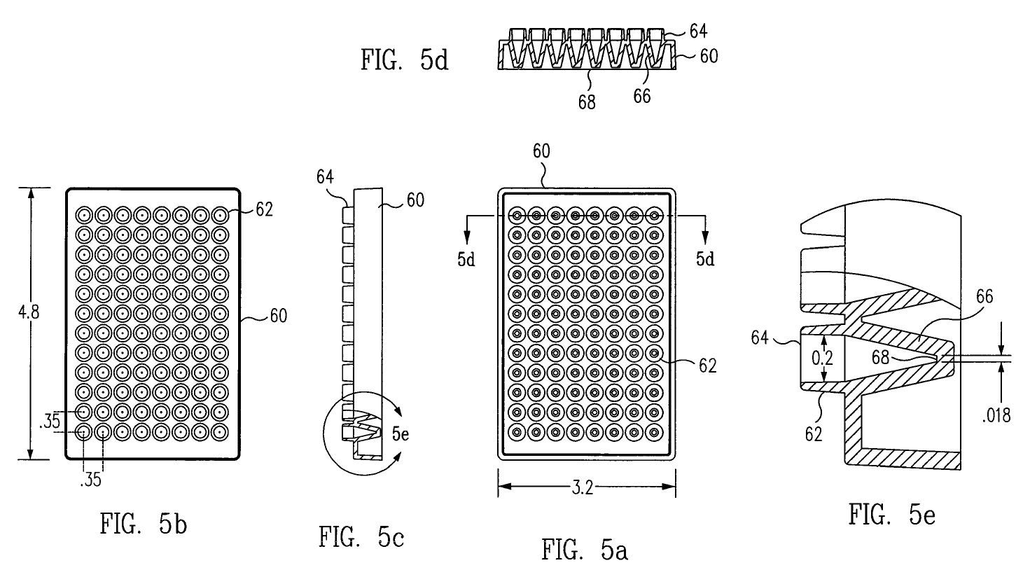

FIGS. 5a-5e are different views of the lower section 60 of the container which press-fits inside of the upper section 30. The lower section 60 supports the capillaries in their upright vertical orientation by supporting the lower ends of the capillaries. Aligned with the holes 40 of the upper section are ninety-six centering supports 62 for the lower ends of the capillaries. As indicated in FIG. 5b, these capillary supports 62 are on the same 0.35 inch center-to-center spacing as the capillary holes 40. The upper part 64 of each of the capillary supports 62 is generally cylindrical with an inner diameter of about 0.2 inches as shown in FIG. 5e, which will easily capture a capillary that is dropped into a hole 40. The lower part 66 of the capillary supports 62 is tapered to a small inner diameter of 0.018 inches at the bottom 68, which is just slightly larger than the diameter of a capillary. Thus, when a capillary is dropped into a hole 40 of the upper section 30, the capillary will fall toward the lower section 60, be captured by the large diameter of the upper part 64, then be guided by the inner wall of the lower part 66 to the small bottom area 68. With the bottom 68 in alignment with the hole 40 in the upper section, the capillary will be caused to stay upright in its vertical orientation from which it can be easily and assuredly located and gripped by a capillary gripper of the automated assay system. Thus, the container of the present invention can be used as a capillary rack operable with an automated capillary gripper in an automated assay system.

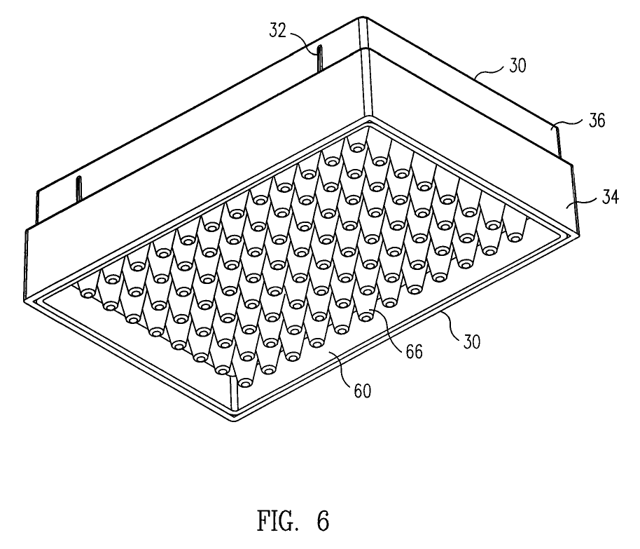

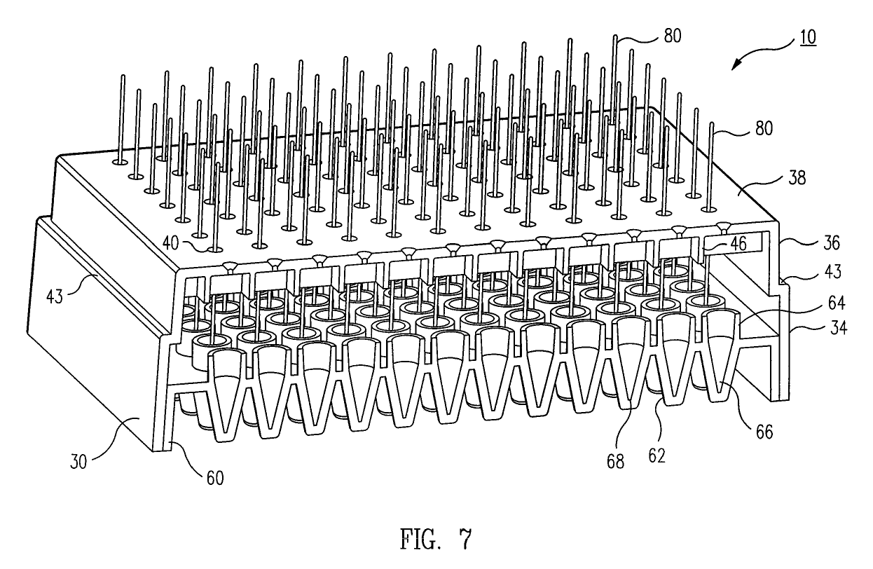

The lower section 60 measures about 3.2 inches wide by 4.8 inches long as shown in FIGS. 5a and 5b which will snugly press-fit inside the upper section 30. FIG. 6 is a perspective view looking upward at the container from below after the lower section 60 has been press-fit inside of the upper section 30. The outside of the tapered lower parts 66 of the capillary supports 62 can be seen inside the lower section 60 of FIG. 6, just as they can in the views of the lower section 60 of FIGS. 5a, 5d and 5e.

FIG. 7 is a cutaway perspective view of a container 10 of the present invention with the cover 12 removed that has been loaded with capillaries 80. As the drawing shows, when a capillary 80 is inserted into a funnel shaped hole 40 on the top 38 of the upper portion 30 of the container, it drops through to the upper part 64 of an aligned centering support 62 of the lower section 60 and the end of the capillary falls to and is supported by the bottom 68 of a tapered lower part 66 of the support 62.

The upper part of each capillary 80 extends about 0.68 inches above the top surface 38 of the upper section 30. A typical capillary is made of glass or a transparent plastic material and is about two inches (50 mm) in length with an outer diameter of about 0.015 inches. When the cover 12 is put in place the cover surrounds the upper portion 36 of the upper section 30 of the container down to the shoulder 43 between the upper and lower portions 36, 34 of the section 30 and provides clearance for the upward extending capillary between the top surface 38 and the inner surface of the top 22 of the cover 12. In a constructed embodiment there is about 0.70 inches of clearance between the top surface 38 and the inner surface of the cover 12, which prevents the capillaries from coming out of the holes during handling and shipping of a loaded container. When a loaded container has arrived at a user's facility the capillaries 80 can be stored in the container 10 until they are to be used. When the capillaries are to be put to use in an automated assay system, the cover 12 is removed from the container 10 and the rest of the container, comprising the upper and lower sections 30 and 60, loaded with the capillaries 80, is put on a capillary holder station of the assay system. The capillaries are then ready for automated access and use in an analytical procedure of the assay system.

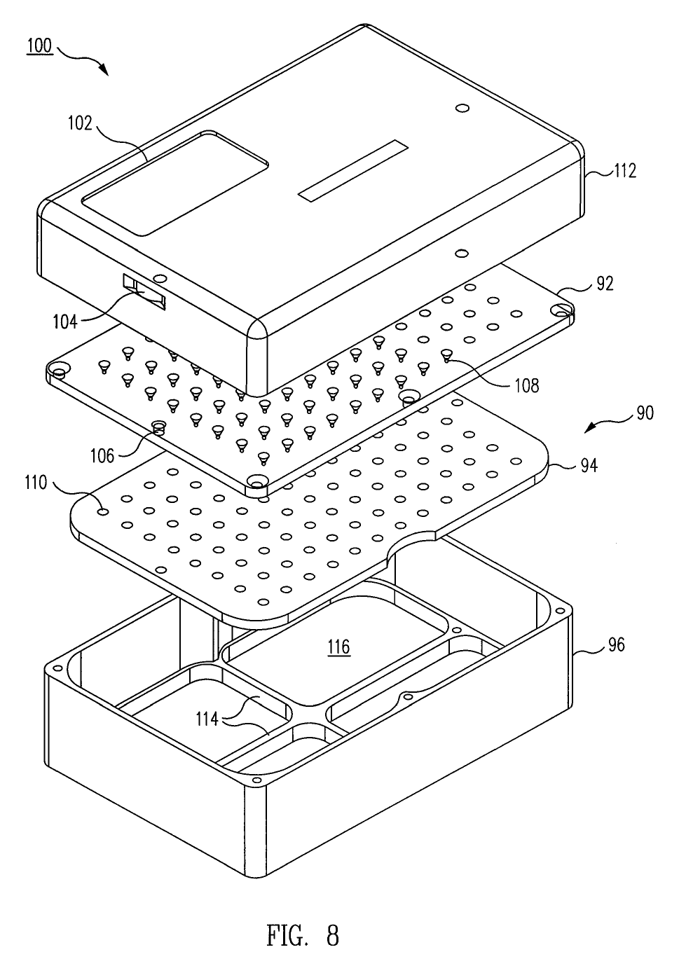

FIG. 8 is an exploded view of a capillary container 100 made up of a lower assembly 90 and a cover 112. The container 100 may be made of a polymeric material, preferably with coated or embedded conductive properties, or it may be stamped or machined from a metal such as aluminum. The lower assembly consists of an upper guide plate 92, lower guide plate 94 and base 96. Cover 112 attaches to the lower assembly 90 with two thumbscrews 104 and, like cover 12 of FIG. 1, has clearance underneath for capillaries. An identifying label 102 may be affixed to cover 112. The label 102 preferably is machine readable such as by means of an RFID element or bar code which can be used to identify the contents of the container. The coded information may identify the interior coating of the capillaries inside the container, for instance. The information of the label can be used to inventory stored containers and track containers during shipment if desired. Upper guide plate 92 has a grid of funnel shaped holes 108 for positioning capillaries in a vertical orientation. Threaded holes 106 receive thumbscrews 104 for securing cover 112. Lower-guide plate 94 has a grid of funnel shaped holes 110 also for positioning capillaries in a vertical orientation. Base 96 is cut out to receive lower guide plate 94 and has an inner bottom surface 116 on which the ends of the capillaries rest. Lower guide plate 94 is secured to ribs 114. Ribs 114 space the lower guide plate 94 above the bottom surface 116 of the base 96 and also stiffen the bottom and prevent warping of base 96. Ribs 114 space the lower guide plate 94 about one-quarter inch above the bottom surface 116 of the base. The guide plates are approximately one-eighth inch thick and are spaced apart about three-quarters of an inch. Upper guide plate 92 is secured to the top of base 96. The funnel shaped holes in guide plates 92, 94 are held in relative alignment by base 96 so as to position capillaries vertically and in predetermined locations, with each aligned guide plate hole providing circumferential support for a capillary and the end of the capillary resting on the bottom surface 116. The outer dimensions of the bottom of the base 96 are chosen to match those of the footprint of a capillary rack station of the automated assay system with which the container is to be used. With the cover 112 attached, capillaries in the container are protected from environmental and physical hazards and may be shipped to a user. Upon receipt the cover is removed and the container placed on the capillary rack station of the automated assay system for use.

It is generally preferred to have container for capillaries in the standard 96 and 384 configurations. In the 96 configuration, the center-to-center spacings ranging is about 9 mm. In the 384 configuration, the center-to-center spacings ranging is about 4.5 mm. Thus the spacing of the capillaries will be similar to the standard 96 well plates and 384 well plates so that these standard plates can be used to store samples and/regents to be loaded to the capillaries. However, in some embodiments, such standard 9 mm spacing of 96 capillaries is problematic as such spacing requires a much bigger footprint and creates complexity in manipulating the capillaries. The inventors have discovered that contrary to the standard use in the industry, a different configuration as provided by some embodiments of the present invention is advantageous in carrying out the assaying of biological samples. In one embodiment, a narrower spacing is employed which enables advantage for the separation and/or detection steps by promoting easier image capturing. In prior art system, capillaries need to be rearranged between a narrow spacing that is less than 9 mm and a 9 mm spacing. Embodiments of the present invention provides a container with particular spacing between the capillaries that is compatible with the assay system where narrow spacing is used for capillaries handling. Such narrow spacing (about 4.5 mm for 96 capillaries) is different from the standard adopted by the industry, but provide the surprising advantages to enable a faster and simpler process to carry out the assay described in U.S. Pat. App. Pub. Nos.: 20060029978 and 20030032035.

Thus, in another aspect, the present invention provides a container where the capillaries are very closely spaced, with center-to-center spacing ranging from 4.5 mm to 9 mm. The density of capillaries in the capillary racks is also substantial, with a full rack holding 96 to 384 capillaries.

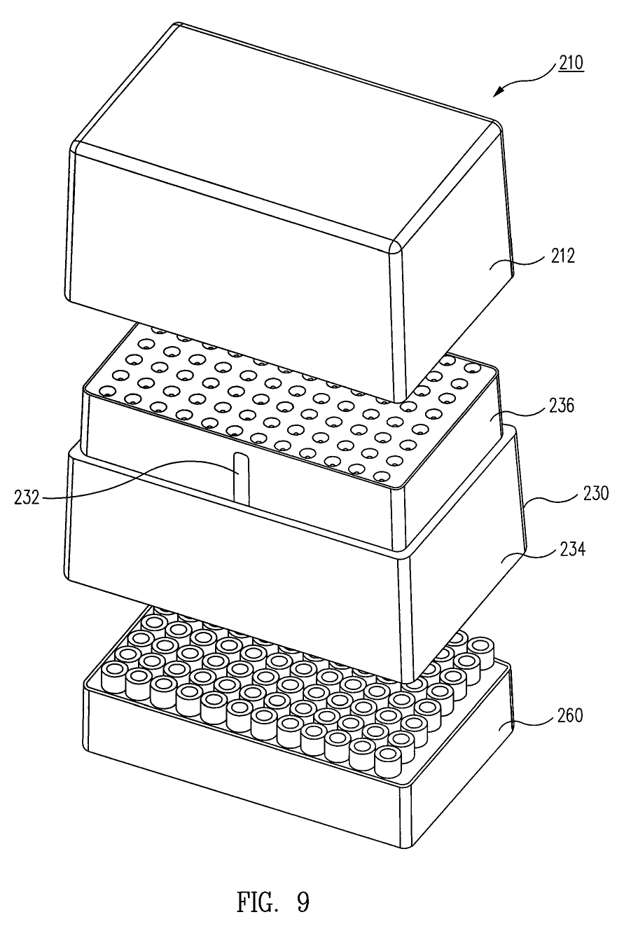

Another exemplary embodiment of the invention is shown in FIGS. 9-15. In this embodiment, the distance between the adjacent holes that hold capillaries is about 4.5 mm, which is about half of the distances of 9 mm in the above described embodiment. This container thus occupies a smaller footprint and enables tighter packing of the capillaries.

Referring first to FIG. 9, the parts of a capillary storage and dispensing container 210 constructed in accordance with the principles of the present invention are shown in a perspective assembly view. The container can be made of a variety of materials such as metal or plastic. A preferred material is acrylonitrile butadiene styrene (ABS), a thermoplastic copolymer which can advantageously be injection-molded to form the parts of the box. An advantage of ABS is that it combines the strength and rigidity of the acrylonitrile and styrene polymers with the toughness of the polybutadiene rubber. ABS can also be formulated to resist static buildup, which could cause handling or optical problems in the automated assay system. A suitable material is Cycolac® ABS plastic, which is available from GE Plastics of Pittsfield, Mass. ABS can also be formulated with additives to be electrically conductive and thereby reduce static buildup. Suitable ABS polymers with these electrical properties are LNP*Stat-kon* or LNP*Stat-loy*, both available from GE Plastics. Alternatively, the polymeric container can be coated with an anti-static coating.

The container 210 has a cover 212 which fits over a base that holds a plurality of capillaries in a vertical, upright position. The base is formed of two sections which press-fit together, an upper section 230 and a lower section 260. The bottom portion 234 of the upper section 230 is wider than the top portion 236 so that the cover 212 will fit over the top portion and cover the capillaries, while the bottom portion fits snugly over and around the lower section 260 of the base in a secure press-fit. When the top and bottom sections 230, 260 are mated together, the capillary holes in the top of the upper section 230 are in alignment with the capillary receivers of the lower section 260, which cooperate to hold the capillaries upright with the circumferential holes in the top and the funneled receivers in the bottom. The removable cover 212 is retained over the top portion 236 of the base by engagement with two ribs 232, one of which is molded on either side of the top portion 236 of the base.

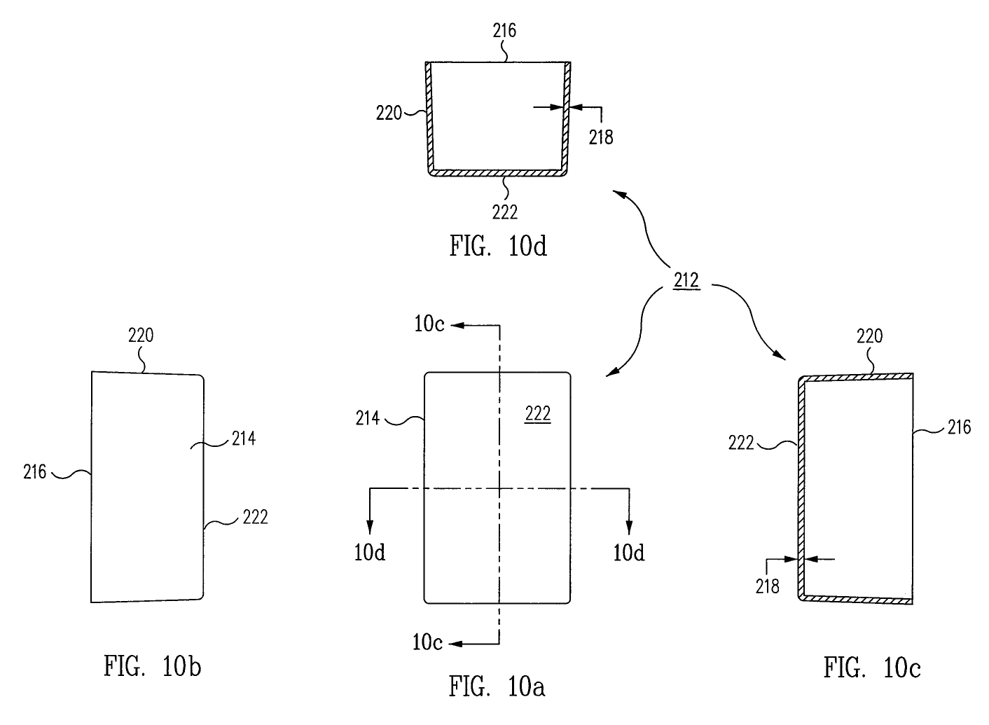

FIGS. 10a-10d show various views of the cover 212 according to some embodiments. FIG. 10a is a top plan view of the cover 212, which is about 1.6 inches wide, 2.5 inches long, and 1.46 inches high. FIG. 10b is a side plan view of the cover, FIG. 10c is a cross-sectional view taken along cut line 10c of FIG. 10a, and FIG. 10d is a cross-sectional view taken along cut line 10d of FIG. 10a. The cover has a nominal wall thickness 218 of about 0.08 inches. The sides 224, 220 of the cover are slightly inclined outward from the top 222 to the opening 216 so that the cover will easily engage the top portion 236 of the base.

FIG. 11 is a perspective view looking at the top of the assembled base of the container 210. In this view only the upper section 230 of the base is visible because in the assembled base the lower section 260 of the base is fully inside the upper section with the bottom edges of both sections flush with each other and forming the bottom of the base. Holes 240 which hold the capillaries are formed through the top 238 of the upper section 230. Preferably the holes 240 are in a grid pattern which is familiar to and in common use in the biological assay field so that the container will hold a number of capillaries which is compatible with other assay equipment and devices. In the container shown in the drawings the grid of holes is eight holes wide by twelve holes long and the container will hold ninety-six capillaries when full. This is the same grid pattern as that of the familiar microwell plates used in biological assaying. However, as described herein, while the guiding pattern is similar, the spacing configuration is unique, wherein the container of ninety-six capillaries of the present invention is much smaller than, such as about a quarter of, the size of the ninety-six well capacity of one of the standard microwell plates. Thus, a containers of the present invention is particularly configured as suitable to provide capillaries for the assaying of samples in the ninety-six wells of the plate of a system described in the provisional application titled “Capillary Immunoassay Systems and Methods” concurrently herewith filed on Apr. 17, 2009, the disclosure of which is incorporated herein by reference in its entirety. Other convenient capillary capacities such as 384 capillaries may also be employed if desired.

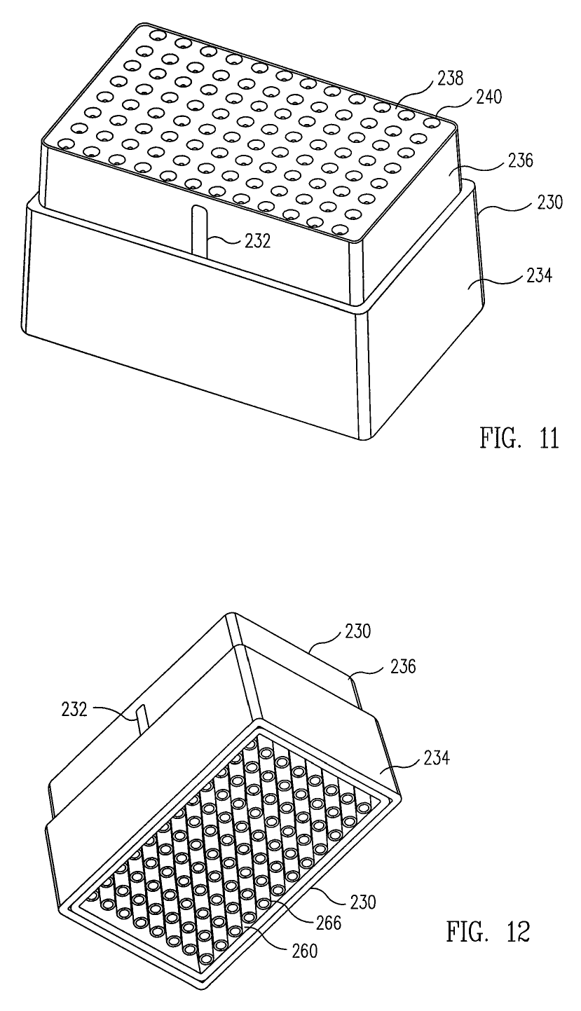

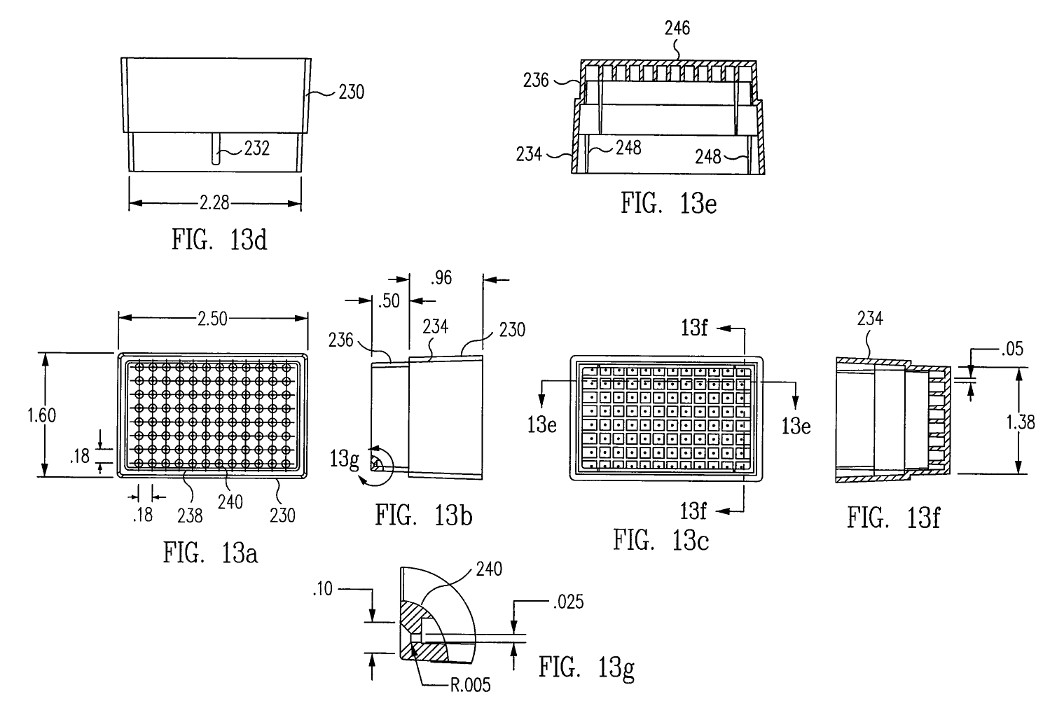

Details of the upper section 230 are shown in FIGS. 13a-13g according to some embodiments of the present invention. FIG. 13a is a top plan view of the upper section 230. The section 230 has a narrower upper portion 236 which is about one-half inch high, as shown in FIG. 13b. The cover 212 fits over this upper portion 236 and is retained in place by the two outer ribs 232. The wider lower portion 234 is about 0.96 inches high and forms the base of the container. The lower section 260 of the container fits inside this lower portion 234 and is retained in contact with ribs 248. Both portions are slightly tapered on the sides, with the base of the lower portion 234 measuring about 1.60 by 2.5 inches, which is sized to fit in the profile for a capillary rack on the base of the assay system with which it is to operate. If the footprint of the container is smaller than the size of the capillary rack station of the assay system, an adapter can be provided which fits the system footprint and accommodates the smaller container, in which case the container for the system operably includes the adapter. The top 238 measures about 1.38 by 2.28 inches as shown in FIGS. 13d and 13f. The ninety-six holes for the capillaries are located in the top surface as shown in FIG. 13a and the holes are evenly spaced on 0.18 inch (4.5 mm) centers in eight rows of twelve holes each as shown in this drawing. At the top the holes are funnel-shaped as best seen in the enlarged cutaway view of FIG. 13g. At the surface of the top 238 the capillary holes 240 have a diameter of 0.10 inches which tapers down to a diameter of 0.025 inches in the thickness of the top 238. The transition from the funnel shape to the constant diameter of the capillary hole 240 has about a 0.005 inch radius. The nominal diameter of 0.025 inches for the capillary holes is about twice the nominal diameter of a capillary.

To provide rigidity for the top surface 238 and prevent warping and bending, an egg-crate ribbing 246 is formed inside the upper portion 236. The sections of the ribs inside of the periphery are on the same 0.18 inch spacing as the capillary holes 240. The thickness of the ribbing 246 is about 0.05 inches as indicated in FIG. 13f. The ribbing 246 in FIGS. 13e and 13f is about 0.25 inches high in a constructed embodiment, occupying approximately the upper half of the inside of the upper portion 236.

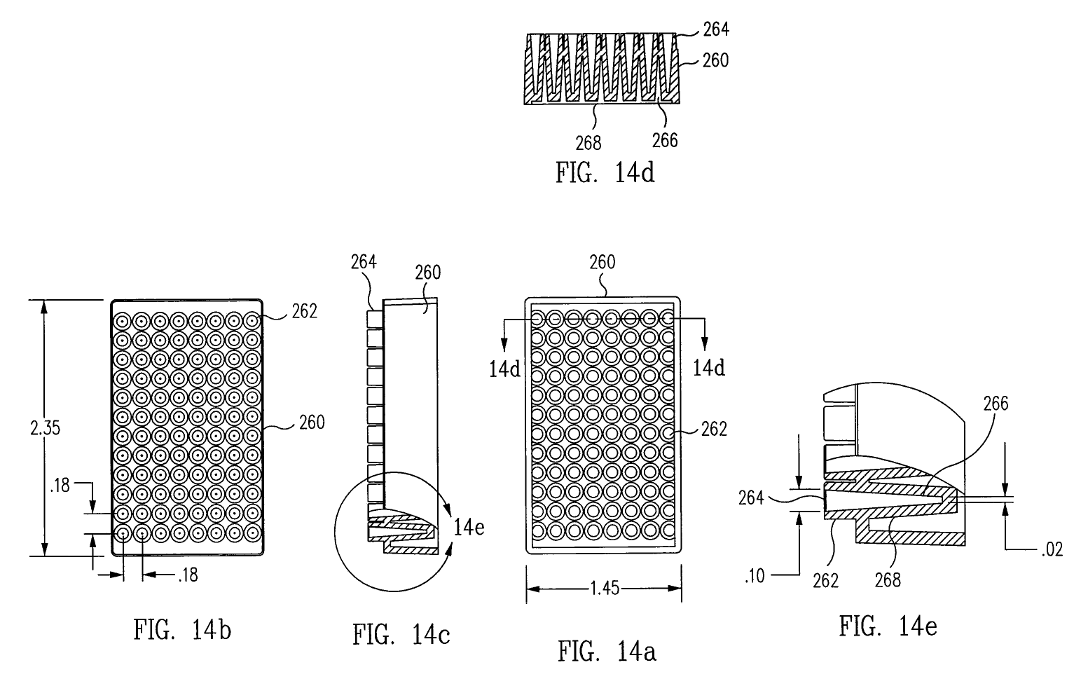

FIGS. 14a-14e are different views of the lower section 260 of the container which press-fits inside of the upper section 230. The lower section 260 supports the capillaries in their upright vertical orientation by supporting the lower ends of the capillaries. Aligned with the holes 240 of the upper section are ninety-six centering supports 262 for the lower ends of the capillaries. As indicated in FIG. 14b, these capillary supports 262 are on the same 0.18 inch center-to-center spacing as the capillary holes 240. The upper part 264 of each of the capillary supports 262 is generally cylindrical with an inner diameter of about 0.1 inches as shown in FIG. 14e, which will easily capture a capillary that is dropped into a hole 240. The lower part 266 of the capillary supports 262 is tapered to a small inner diameter of 0.02 inches at the bottom 268, which is just slightly larger than the diameter of a capillary. Thus, when a capillary is dropped into a hole 240 of the upper section 230, the capillary will fall toward the lower section 260, be captured by the large diameter of the upper part 264, then be guided by the inner wall of the lower part 266 to the small bottom area 268. With the bottom 268 in alignment with the hole 240 in the upper section, the capillary will be caused to stay upright in its vertical orientation from which it can be easily and assuredly located and gripped by a capillary gripper of the automated assay system. Thus, the container of the present invention can be used as a capillary rack operable with an automated capillary gripper in an automated assay system.

The lower section 260 measures about 1.6 inches wide by 2.5 inches long as shown in FIGS. 14a and 14b which will snugly press-fit inside the upper section 230. FIG. 12 is a perspective view looking upward at the container from below after the lower section 260 has been press-fit inside of the upper section 230. The outside of the tapered lower parts 266 of the capillary supports 262 can be seen inside the lower section 260 of FIG. 12, just as they can in the views of the lower section 260 of FIGS. 14a, 14d and 14e.

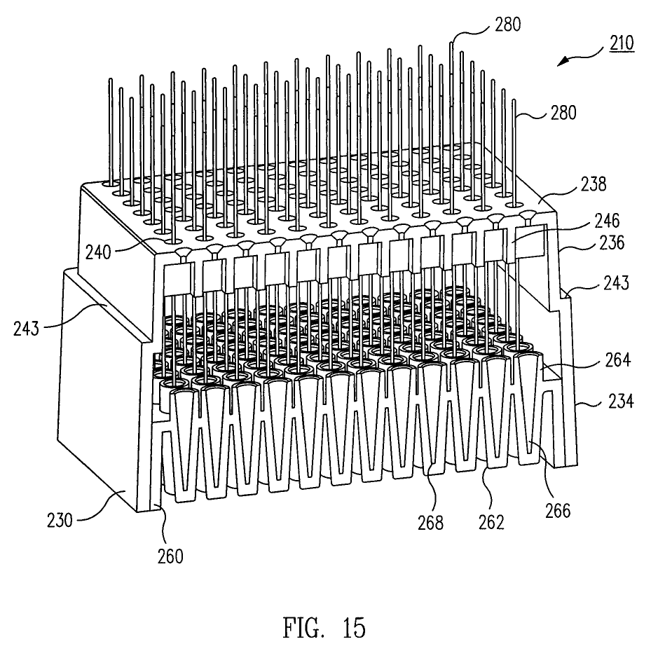

FIG. 15 is a cutaway perspective view of a container 210 of the present invention with the cover 212 removed that has been loaded with capillaries 280. As the drawing shows, when a capillary 280 is inserted into a funnel shaped hole 240 on the top 238 of the upper portion 230 of the container, it drops through to the upper part 264 of an aligned centering support 262 of the lower section 260 and the end of the capillary falls to and is supported by the bottom 268 of a tapered lower part 266 of the support 262.

The upper part of each capillary 280 extends about 0.68 inches above the top surface 238 of the upper section 230. A typical capillary is made of glass or a transparent plastic material and is about two inches (50 mm) in length with an outer diameter of about 0.015 inches. When the cover 212 is put in place the cover surrounds the upper portion 236 of the upper section 230 of the container down to the shoulder 243 between the upper and lower portions 236, 234 of the section 230 and provides clearance for the upward extending capillary between the top surface 238 and the inner surface of the top 222 of the cover 212. In a constructed embodiment there is about 0.70 inches of clearance between the top surface 238 and the inner surface of the cover 212, which prevents the capillaries from coming out of the holes during handling and shipping of a loaded container. When a loaded container has arrived at a user's facility the capillaries 280 can be stored in the container 210 until they are to be used. When the capillaries are to be put to use in an automated assay system, the cover 212 is removed from the container 210 and the rest of the container, comprising the upper and lower sections 230 and 260, loaded with the capillaries 280, is put on a capillary holder station of the assay system. The capillaries are then ready for automated access and use in an analytical procedure of the assay system.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes.

We claim:

1. A capillary container which holds a plurality of capillaries in a vertical position which is suitable for use in an automated assay system comprising:
a removable cover which can be secured on top of the container, the cover providing clearance for the upper portions of a plurality of capillaries which are loaded into the container; and
a base having a plurality of holes arranged in a grid-like pattern which hold capillaries in an upright vertical position, the holes holding the capillaries in a vertical orientation by circumferentially surrounding the capillaries, the base having a lower portion with positions aligned vertically with the tops of the holes which support the capillaries at the bottom ends of the capillaries.

2. The capillary container of claim 1, wherein the holes are funnel-shaped at the top to provide for ease in insertion of the capillaries into the holes.

3. The capillary container of claim 1, wherein the holes are arranged in a grid-like pattern of ninety-six holes of eight rows of twelve holes, whereby a fully loaded container contains ninety-six capillaries.

4. The capillary container of claim 1, wherein the holes are arranged in a grid-like pattern of 384 holes of sixteen rows of twenty-four holes, whereby a fully loaded container contains 384 capillaries.

5. The capillary container of claim 1, wherein the positions supporting the capillaries at the bottom ends comprise tapered apertures each of which guides an inserted capillary to a position vertically aligned with the top a hole which is slightly larger than the diameter of a capillary.

6. The capillary container of claim 1, wherein the base measures approximately 1.6 inches by 2.5 inches.

7. The capillary container of claim 1, wherein the grid-like pattern of holes further comprises a plurality of holes with a 0.18 inch center-to-center spacing.

8. The capillary container of claim 1, wherein the base exhibits a space between the part of the holes which circumferentially surround the capillaries at the top of the hole and the lower portion which supports the capillaries at the bottom ends of the capillaries.

9. The capillary container of claim 1, wherein the base further comprises:
a top surface having a plurality of funnel-shaped holes formed therein, and
a support structure, located beneath the top surface, which provides rigidity to the top surface.

10. The capillary container of claim 8, wherein the support structure further comprises an egg-crate like ribbing.

11. The capillary container of claim 10, wherein the egg-crate like ribbing further comprises orthogonal members which are on a 0.18 inch spacing.

12. The capillary container of claim 1, wherein the base further comprises:
an upper portion including a top surface having the plurality of funnel-shaped holes arranged in the grid-like pattern which support vertically oriented capillaries by providing circumferential support to the capillaries; and
a lower portion providing the inside bottom of the container and providing the positions vertically aligned with the tops of the holes of the top surface, the lower portion supporting the capillaries at the bottom ends of the capillaries.

13. The capillary container of claim 12, wherein the lower portion fits inside of the upper portion.

14. The capillary container of claim 13, wherein the lower portion includes a plurality of tapered apertures which guide inserted capillaries to the positions supporting the bottom ends of the capillaries.

15. The capillary container of claim 1, wherein, when the cover is in place on the base, capillaries in the container extend over half the distance between the tops of the holes in the base and the top of the cover.

16. The capillary container of claim 1, wherein the cover and the base are fabricated of a polymeric material.

17. The capillary container of claim 1, wherein the cover and the base are fabricated of a metallic material.

18. The capillary container of claim 1, further comprising an intermediate guide plate located between the plurality, of holes of the base and the lower portion of the base, the intermediate guide plate having a plurality of holes vertically aligned with the plurality of holes of the base,
wherein aligned holes of the base and the guide plate both provide circumferential vertical alignment for a capillary inserted through the holes.

19. The capillary container of claim 1, wherein the removable cover further comprises a, machine readable label identifying the contents of the container.

20. An injection molded polymeric capillary container which holds ninety-six capillaries in a vertical position comprising:
a polymeric base which holds the capillaries in a vertical position by a top surface with ninety-six holes which circumferentially surround the- capillaries, with the capillaries extending over one-half inch above the top surface, and a bottom which supports the bottom ends of the capillaries in ninety-six predetermined positions which are vertically aligned with the holes of the top surface; and
a polymeric cover which removably fits over the top of the base and covers the capillaries that are located in the base.

21. The injection molded polymeric capillary container of claim 20, wherein the polymer is electrically conductive to retard static buildup.

22. The injection molded polymeric capillary container of claim 20, wherein the polymeric base comprises two portions:
an upper portion having a structurally reinforced top surface containing ninety-six funnel shaped holes for receiving capillaries; and
a lower portion which press-fits together with the upper portion, the lower portion having ninety-six centering supports which support the ends of capillaries in vertical alignment with the funnel shaped holes and are tapered to locate the ends of the capillaries at the ninety-six positions.

23. The injection molded polymeric capillary container of claim 20, wherein the polymeric base further includes a shoulder which defines the position of the cover when the cover is fit over the top of the base, the defined position providing a space between the cover and the base into which capillaries loaded into the container can extend, the capillaries extending over half of the distance between the top of the base and the cover.

24. A capillary container which holds a plurality of capillaries in a vertical position which is suitable for use in an automated assay system comprising:
a removable cover which can be secured on top of the container, the cover providing clearance for the upper portions of a plurality of capillaries which are loaded into the container; and
a base having a plurality of holes arranged in a grid-like pattern which hold capillaries in an upright vertical position, the holes holding the capillaries in a vertical orientation by circumferentially surrounding the capillaries, the base having a lower portion with positions aligned vertically with the tops of the holes which support the capillaries at the bottom ends of the capillaries,
wherein said container holds 96 capillaries with about 4.5 mm center-to-center spacing.

25. The capillary container of claim 24, wherein the base measures approximately 1.6 inches by 2.5 inches.

26. An injection molded polymeric capillary container which holds ninety-six capillaries in a vertical position comprising:
a polymeric base which holds the capillaries in a vertical position by a top surface with ninety-six holes which circumferentially surround the- capillaries, with the capillaries extending over one-half inch above the top surface, and a bottom which supports the bottom ends of the capillaries in ninety-six predetermined positions which are vertically aligned with the holes of the top surface; and
a polymeric cover which removably fits over the top of the base and covers the capillaries that are located in the base,
wherein said container holds capillaries with about 4.5 mm center-to-center spacing.

27. The capillary container of claim 26, wherein the base measures approximately 1.6 inches by 2.5 inches.
